(19) United States
(12) Patent Application Publication
(10) Pub. No.: US 2025/0263982 A1
(43) Pub. Date: Aug. 21, 2025

(54) TUNNEL DRAINAGE METHOD FOR LAYING DRAINAGE PIPE BASED ON ULTRA-LONG DISTANCE HORIZONTAL DIRECTIONAL DRILLING

(71) Applicant: CCCC SECOND HIGHWAY CONSULTANTS CO., LTD., Wuhan (CN)

(72) Inventors: Jiguo LIU, Wuhan (CN); Erlin WU, Wuhan (CN); Heng SHU, Wuhan (CN); Xialin LIU, Wuhan (CN); Longhai WEI, Wuhan (CN); Wenbo PENG, Wuhan (CN); Qinglong CUI, Wuhan (CN); Ming SONG, Wuhan (CN); Yalina MA, Wuhan (CN); Kai WANG, Wuhan (CN); Danni LI, Wuhan (CN)

(73) Assignee: CCCC SECOND HIGHWAY CONSULTANTS CO., LTD., Wuhan (CN)

(21) Appl. No.: 19/204,271

(22) Filed: May 9, 2025

Related U.S. Application Data
(63) Continuation of application No. PCT/CN2023/130032, filed on Nov. 7, 2023.

(30) Foreign Application Priority Data
Nov. 10, 2022 (CN) 202211402144.0

(51) Int. Cl. E21B 7/04; E03F 3/02; E03F 3/06

(52) U.S. Cl. CPC E21B 7/046; E03F 3/02; E03F 3/06

(57) ABSTRACT

The present disclosure provides a tunnel drainage method. The method includes: for an established existing tunnel, laying a drainage pipe by ultra-long distance horizontal directional drilling in the surrounding rock of the tunnel, wherein the drainage pipe is a horizontal perforated corrugated pipe, and underground water in the surrounding rock of the tunnel is depressurized and discharged through the drainage pipe. The present disclosure uses the ultra-long distance horizontal directional drilling to lay the drainage pipe, which can effectively decompress and discharge the underground water behind a secondary lining.

### CROSS-REFERENCE TO RELATED APPLICATIONS

This application is a continuation of International Patent Application No. PCT/CN2023/130032 with a filing date of Nov. 7, 2023, designating the United States, now pending, and further claims priority to Chinese Patent Application No. 202211402144.0 with a filing date of Nov. 10, 2022. The content of the aforementioned applications, including any intervening amendments thereto, is incorporated herein by reference.

### TECHNICAL FIELD

The present disclosure relates to the technical field of mountain tunnel drainage, in particular to a tunnel drainage method for laying a drainage pipe based on ultra-long distance horizontal directional drilling.

### BACKGROUND ART

In tunnel engineering, circumferential drainage channels and longitudinal drainage channels need to be buried in a tunnel. Generally, the circumferential drainage channels are communicated to the longitudinal drainage channels, so that the underground water behind a tunnel lining is discharged from the longitudinal drainage channels to side ditches on both sides of the tunnel, which reduces the water pressure behind the lining structure.

After long-term operation of the tunnel, especially the tunnel in a water-rich stratum, the drainage channels are easy to be blocked due to crystallization or other reasons, resulting in the increase of underground water pressure behind a secondary lining and resulting in water leakage, cracking, chipping and other problems of the secondary lining. Therefore, the underground water behind the secondary lining needs to be depressurized and discharged. After retrieval, it is found that:

The Chinese invention patent with the application publication number of CN104061017A discloses a method and device for maintainable decompression and drainage for tunnels in water-rich strata. Steps are as follows: A. arranging a drainage tank circumferentially along the deformation joint of the tunnel lining; B. making water diversion holes in the direction of surrounding rock in the tank; C. using fasteners to fix a semicircular pipe in the drainage tank to form a drainage channel; and D. reserving a water collection tank at the bottom of the semicircular pipe, and introducing water into drainage side ditches through a corrugated pipe. The drainage tank is arranged on a cover plate of a cable trench; the semicircular pipe is arranged in the drainage tank; the water diversion holes are made on one side in the drainage tank at an equal distance; a waterproof plate with non-woven fabric is wrapped around the semicircular pipe; the semicircular pipe is fixed on the wall of the drainage tank through the fasteners on both sides of the waterproof plate; the water collection tank is connected to the semicircular pipe through the corrugated pipe; and the drainage pipe is connected with the water collection tank.

The Chinese invention patent with the application publication number of CN110630325A discloses a drainage method for a long distance tunnel by horizontal directional drilling, including: step 1: arranging a first water retaining wall on a tunnel face near a parallel adit exit section; not sealing the lower part of the first water retaining wall to form a water outlet; reinforcing the surrounding rock by an anchor rod; arranging a second water retaining wall and a third water retaining wall; arranging gutters on the left and right sides of a tunnel section between the first water retaining wall and the second water retaining wall and on the left and right sides of a transverse gallery; and constructing drainage channels connected with the natural ditch at the exit of the transverse gallery; step 2: carrying out site investigation, site layout, guide line design and surveying and setting out; step 3: positioning and testing a drill; step 4: drilling by the drill; and step 5: quickly cleaning up and restoring the site.

However, the methods and the device in the above patents also have the following problems:
1. Decompression and drainage are mainly carried out in the annular direction at the deformation joint or the settlement joint of the tunnel. Due to the long longitudinal direction of the tunnel, the effect of decompression and drainage is limited when only the drainage in the annular direction is considered;
2. This method for decompression and drainage for tunnels in water-rich strata requires to make the water diversion holes in the surrounding rock of the tunnel, which will damage the secondary lining structure of the tunnel to a certain extent;
3. The patent for the method for long distance tunnel drainage by horizontal directional drilling is dedicated to the tunnels without holing-through, and cannot solve the drainage problem of the built tunnel.

Therefore, it is necessary to provide a drainage method for laying a drainage pipe based on ultra-long distance horizontal directional drilling, to solve at least one of the above technical problems.

### SUMMARY OF THE INVENTION

In view of the defects in the prior art, the purpose of the present disclosure is to provide a tunnel drainage method for laying a drainage pipe based on ultra-long distance horizontal directional drilling.

According to one aspect of the present disclosure, a tunnel drainage method is provided, including:
for an established existing tunnel, laying a drainage pipe by ultra-long distance horizontal directional drilling in the surrounding rock of the tunnel;
wherein the drainage pipe is a horizontal perforated corrugated pipe, and underground water in the surrounding rock of the tunnel is discharged through the drainage pipe.

Optionally, a hole is drilled in the surrounding rock of the tunnel by ultra-long distance horizontal directional drilling, a horizontal directional drilling reamer is used for reaming to pull back and lay the drainage pipe, and an external drainage pipe is used to direct the underground water in the surrounding rock into side ditches of the tunnel for discharge.

Optionally, the horizontal directional drilling can be adapted to a straight section or a curved section of the tunnel under the action of a drill guide system to achieve drilled crossing with controlled angle and direction in the surrounding rock of the tunnel.

Optionally, the row number of horizontal directional drilled holes is determined according to the actual water yield of a water-rich stratum on site, and may be 1 row, 2 rows or 3 rows; and the height of the bottom row of the horizontal directional drilled holes is determined according to the actual operating height required by a horizontal directional drill.

Optionally, if the length of the tunnel is less than 1000 m, the tunnel is a medium or short tunnel, and holes can be drilled by ultra-long distance horizontal directional drilling at a tunnel portal; and if the length of the tunnel is greater than or equal to 1000 m, the tunnel is a long tunnel and holes can be drilled by ultra-long distance horizontal directional drilling at a baffle wall of an emergency parking strip of the tunnel and a side wall of a transverse gallery for vehicles.

Optionally, the drainage pipe adopts a perforated corrugated pipe, and the external drainage pipe adopts a PVC drainage pipe. The drilled hole of the horizontal directional drilling is a horizontal hole with a diameter of 110-130 mm, and the diameter of the perforated corrugated pipe is 100-120 mm.

Optionally, the drainage pipe, when blocked, is dredged by flushing with high pressure water.

Compared with the prior art, the present disclosure has at least one of the following beneficial effects:
1. With respect to the built tunnel, the present disclosure uses the ultra-long distance horizontal drilling to lay the drainage pipe, which can effectively decompress and discharge the underground water behind the secondary lining and make the construction simple and convenient. The decompression and drainage method provided by the present disclosure solves the drainage problem without destroying the secondary lining structure of a main cave, which is conducive to the safety of the tunnel structure;
2. In the process of implementing drilling in the present disclosure, the operation is carried out in the emergency parking strip, in the transverse gallery for vehicles or outside the tunnel portal. At the same time, after drilling and laying the drainage pipe, the external drainage pipe is adopted, and the underground water is not dispersed and diffused in the tunnel; and the driving safety is not affected during and after the operation process;
3. The drilling method adopted by the present disclosure forms a hole at one time, and the horizontal directional drilling reamer is used for reaming to pull back and lay the drainage pipe, with the advantage of high implementation efficiency.

### BRIEF DESCRIPTION OF THE DRAWINGS

By reading the detailed description of the non-limiting embodiments with reference to the following drawings, other features, purposes and advantages of the present disclosure will become more apparent:

FIG. 1 is a planar arrangement schematic diagram of ultra-long distance horizontal directional drilling in an embodiment of the present disclosure;

FIG. 2 is a cross-sectional arrangement schematic diagram of ultra-long distance horizontal directional drilling in an embodiment of the present disclosure (located in a tunnel);

FIG. 3 is a cross-sectional arrangement schematic diagram of ultra-long distance horizontal directional drilling in an embodiment of the present disclosure (located outside a tunnel);

FIG. 4 is an arrangement schematic diagram of pulling back and laying a drainage pipe in a tunnel in an embodiment of the present disclosure;

FIG. 5 is a structural schematic diagram of an external drainage pipe in an embodiment of the present disclosure.

In the figures: 1 tunnel; 2 emergency parking strip; 3 transverse gallery for vehicles; 4 horizontal drilled hole; 5 drilling position; 6 tunnel portal; 7 horizontal directional drill; 8 drill pipe; 9 reamer; 10 perforated corrugated pipe; 11 external drainage pipe; 12 side ditch.

### DETAILED DESCRIPTION OF PREFERRED EMBODIMENTS

The present disclosure will be described in detail below in combination with specific embodiments. The following embodiments will assist those skilled in the art to further understand the present disclosure, but are not intended to limit the present disclosure in any way. It should be noted that, for those ordinary skilled in the art, several deformations and improvements can also be made without departing from the concept of the present disclosure, all of which belong to the protection scope of the present disclosure.

Embodiments of the present disclosure provide a tunnel drainage method for laying a drainage pipe based on ultra-long distance horizontal directional drilling. The method includes:
for an established existing tunnel, laying a drainage pipe by ultra-long distance horizontal directional drilling in the surrounding rock of the tunnel. The drainage pipe is a horizontal perforated corrugated pipe, and underground water in the surrounding rock of the tunnel is discharged through the drainage pipe.

In some embodiments, a hole is drilled in the surrounding rock of the tunnel by ultra-long distance horizontal directional drilling, a horizontal directional drilling reamer is used for reaming to pull back and lay the drainage pipe, and an external drainage pipe is used to direct the underground water in the surrounding rock into side ditches of the tunnel for discharge. After drilling and laying the drainage pipe, the external drainage pipe is adopted, and the underground water is not dispersed and diffused in the tunnel, which can ensure that the driving safety is not affected after the completion of the operation. Wherein the vertical number (row number) of horizontal directional drilled holes is determined according to the actual water yield of a water-rich stratum on site, and may be 1 row, 2 rows or 3 rows; and the height of the bottom row of the horizontal directional drilled holes is determined according to the actual operating height required by a horizontal directional drill.

In the above tunnel drainage method, the drilling method adopted forms a hole at one time, and the horizontal directional drilling reamer is used for reaming to pull back and lay the drainage pipe, with the advantage of high implementation efficiency.

In some preferred embodiments, the horizontal directional drilling can be adapted to a straight section or a curved section of the tunnel under the action of a drill guide system to achieve drilled crossing with controlled angle and direction in the surrounding rock of the tunnel.

For tunnels with a length of less than 1000 m, that is, medium or short tunnels, holes can be drilled by ultra-long distance horizontal directional drilling at a tunnel portal; and for tunnels with a length of greater than or equal to 1000 m, that is, long tunnels, holes can be drilled by ultra-long distance horizontal directional drilling at a baffle wall of an emergency parking strip of the tunnel and a side wall of a transverse gallery for vehicles. In the process of implementing drilling, the operation is carried out in the emergency parking strip, in the transverse gallery for vehicles or outside the tunnel portal. The driving safety is not affected during the operation process.

In some embodiments, the drainage pipe adopts a perforated corrugated pipe, and the external drainage pipe adopts a PVC drainage pipe. The drilled hole of the horizontal directional drilling is a horizontal hole with a diameter of 110-130 mm, and the diameter of the horizontal perforated corrugated pipe is 100-120 mm.

In the tunnel drainage method in the above embodiments, with respect to the built tunnel, the ultra-long distance horizontal drilling is used to lay the drainage pipe, which can effectively decompress and discharge the underground water behind the secondary lining and make the construction simple and convenient. The decompression and drainage method provided by the present disclosure solves the drainage problem without destroying the secondary lining structure of a main cave, which is conducive to the safety of the tunnel structure.

The present disclosure is described more specifically in combination with the construction steps below. It is necessary to point out here that the following embodiments are only used for further illustration of the present disclosure and shall not be understood as limitations to the protection scope of the present disclosure. Some non-essential improvements and adjustments made by those skilled in the art according to the above contents of the present disclosure shall also belong to the protection scope of the present disclosure.

A tunnel drainage method for laying a drainage pipe based on ultra-long distance horizontal directional drilling provided by the embodiments of the present disclosure includes the following steps:
S1. selecting a tunnel section to be treated according to the site damage conditions (water leakage, cracking, chipping, etc. of the secondary lining), and arranging horizontal drilling;

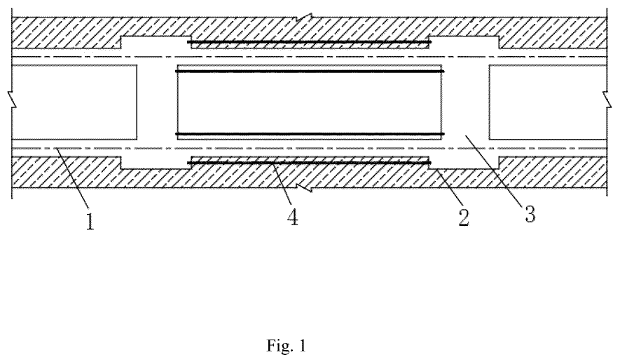

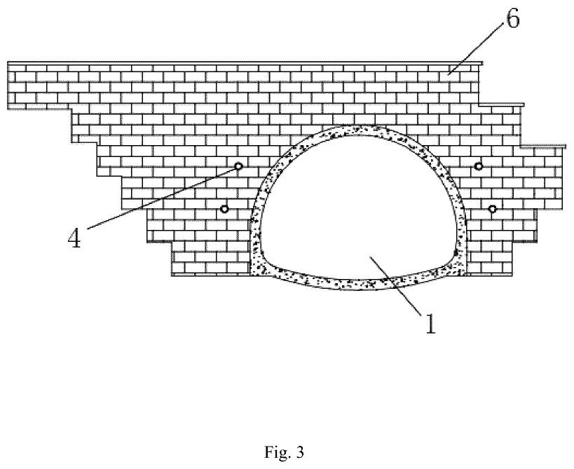

Specifically, by referring to FIG. 1, in a built tunnel 1 (a long tunnel), for a range with more damages (water leakage, cracking, chipping, etc. of the secondary lining), it indicates that the surrounding rock of the tunnel is rich in underground water within the range, and the drainage pipe facilities of the built tunnel are not well drained. Within the range, an emergency parking strip 2 and a transverse gallery 3 for vehicles on both sides are selected as the operation sites to implement ultra-long distance horizontal directional drilling 4. Specifically, the operation of the horizontal drilling 4 is carried out at a baffle wall of the emergency parking strip of the tunnel and a side wall of the transverse gallery for vehicles. In particular, by referring to FIG. 3, for the tunnel 1 (medium and short tunnels) with a length of less than 1000 m, if conditions of similar damages (water leakage, cracking, chipping, etc. of the secondary lining) occur, the operation of the horizontal drilling 4 can be carried out at a tunnel portal 6.
S2. drilling by a horizontal directional drill to form a hole;

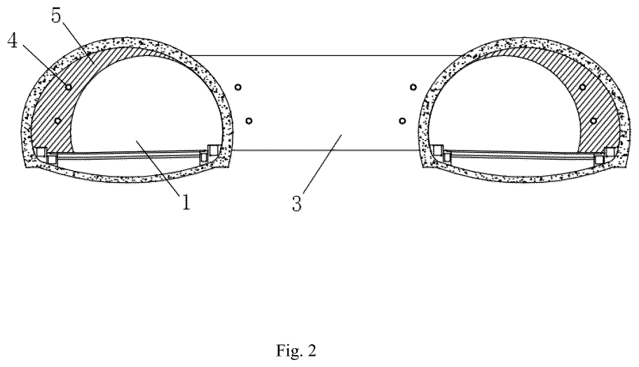

Specifically, by referring to FIG. 2, after making preparations for site layout, drill erection and commissioning, surveying and setting out, etc., horizontal directional drilling is carried out from a drilling position 5. The drilling position 5 includes the baffle wall of the emergency parking strip and the side wall of the transverse gallery for vehicles. That is, a hole (with a diameter of 110-130 mm) is drilled by ultra-long distance horizontal directional drilling at one side of the baffle wall of the emergency parking strip and the side wall of the transverse gallery for vehicles. The hole position is kept a certain distance from the secondary lining of the tunnel. For a straight or curved section of the tunnel, under the action of a guidance system of horizontal directional drilling, the angle and the direction can be controlled. The drilling passes through the other side of the baffle wall of the emergency parking strip and the side wall of the transverse gallery for vehicles to complete the operation of the horizontal drilling 4. For smooth drainage later, the horizontal drilling angle is kept consistent with the longitudinal slope of the tunnel. For the tunnel 1 (medium and short tunnels) with a length of less than 1000 m, a hole (with a diameter of 110-130 mm) is drilled by ultra-long distance horizontal directional drilling at one side of the tunnel portal 6. For the straight or curved section of the tunnel, under the action of the guidance system of horizontal directional drilling, the angle and the direction can be controlled. The drilling passes through the other side of the tunnel portal 6 to complete the operation of the horizontal drilling 4. In particular, the vertical number (row number) of drilled holes of the horizontal drilling 4 can be determined according to the actual water yield of a water-rich stratum on site, and may be 1 row, 2 rows or 3 rows. At the same time, the height of the bottom row of drilled holes of the horizontal drilling 4 is determined according to the actual operating height required by a horizontal directional drill.
S3. pulling back and laying a perforated corrugated pipe by the horizontal directional drill;

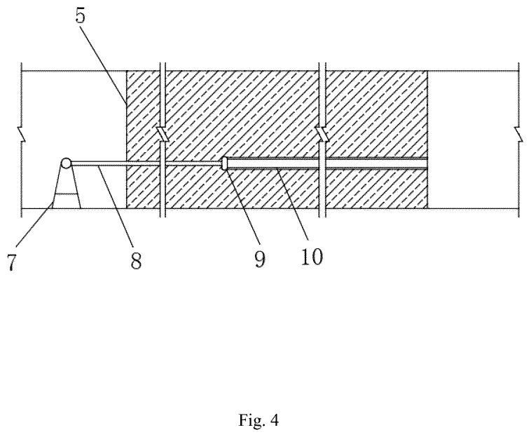

Specifically, by referring to FIG. 4, for the long tunnel, after the hole is formed by using a drill pipe 8 of the horizontal directional drill 7 from the drilling position 5 (the baffle wall of the emergency parking strip and the side wall of the transverse gallery for vehicles), in order to provide a drag space and reduce resistance for the laying of the perforated corrugated pipe 10 (with a diameter of 100-120 mm), a reamer 9 is used to pull back and ream the hole. The front end of the reamer is connected to the perforated corrugated pipe 10. Pullback is conducted from the position of an end point of hole formation of the horizontal drilling 4 to the position of a start point until the perforated corrugated pipe 10 is laid in the entire horizontal drilling 4. The drilling position of the medium and short tunnels is the tunnel portal 6. The hole is formed by using the drill pipe 8 of the horizontal directional drill 7 from the tunnel portal 6. Other embodiments are the same as the embodiments of the long tunnel.
S4. directing the underground water in the surrounding rock into side ditches of the tunnel by an external drainage pipe for discharge;

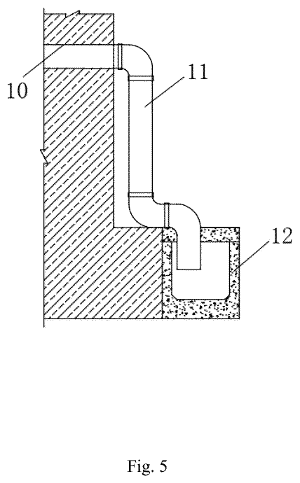

Specifically, by referring to FIG. 5, in order to connect the underground water that flows out from both ends of the perforated corrugated pipe 10 into a tunnel drainage system, a certain number of elbows and straight pipe sections of PVC drainage pipes need to be configured. The external drainage pipe 11 adopts a PVC drainage pipe. The perforated corrugated pipe 10 is connected to the side ditches 12 on both sides of the tunnel by the external drainage pipe 11 for discharge. The underground water is not diffused to the road surface when discharged. The driving safety on the road surface is not affected during use. In particular, in the later operation, if the perforated corrugated pipe 10 is found to be blocked, because the perforated corrugated pipe is laid horizontally and longitudinally, high pressure water can be used for dredging to meet the drainage need.

The specific embodiments of the present disclosure are described above. It should be understood that the present disclosure is not limited to the above specific embodiments. Those skilled in the art can make various variations or modifications within the scope of the claims, which will not affect the essential contents of the present disclosure. The above preferred features can be used in any combination without conflicting with each other.

What is claimed is:

1. A tunnel drainage method, comprising:
for an established existing tunnel, laying a drainage pipe by ultra-long distance horizontal directional drilling in surrounding rock of the tunnel;
wherein the drainage pipe is a horizontal perforated corrugated pipe, and underground water in the surrounding rock of the tunnel is discharged through the drainage pipe;
wherein a hole is drilled in the surrounding rock of the tunnel by ultra-long distance horizontal directional drilling along a longitudinal direction of the tunnel, a position of the hole is distanced from a secondary lining of the tunnel, a horizontal directional drilling reamer is used for reaming to pull back and lay the drainage pipe, and an external drainage pipe is used to direct the underground water in the surrounding rock into side ditches of the tunnel for discharge;
wherein when a length of the tunnel is less than 1000 m, the tunnel is defined as a medium or short tunnel, the hole is drilled by ultra-long distance horizontal directional drilling at a tunnel portal, for a straight or curved section of the tunnel, under an action of a guidance system of the horizontal directional drilling, an angle and a direction of the drilling are controlled, the hole passes through the tunnel portal to complete operation of the horizontal directional drilling; and when the length of the tunnel is greater than or equal to 1000 m, the tunnel is defined as a long tunnel and the hole is drilled by ultra-long distance horizontal directional drilling at a baffle wall of an emergency parking strip of the tunnel and a side wall of a transverse gallery for vehicles, for a straight or curved section of the tunnel, under the action of the guidance system of the horizontal directional drilling, the angle and the direction of the drilling are controlled, the hole passes through the baffle wall of the emergency parking strip and the side wall of the transverse gallery for vehicles to complete the operation of the horizontal directional drilling.

2. The tunnel drainage method according to claim 1, wherein a row number of the holes is determined according to an actual water yield of a water-rich stratum on site; and a height of the holes at a bottommost row is determined according to an actual operating height required by a horizontal directional drill.

3. The tunnel drainage method according to claim 1, wherein the holes are horizontal holes with a diameter of 110-130 mm, and a diameter of the perforated corrugated pipe is 100-120 mm.

4. The tunnel drainage method according to claim 1, wherein the drainage pipe, when blocked, is dredged by flushing with high pressure water.
